(19) United States
(12) Patent Application Publication
(10) Pub. No.: US 2016/0266566 A1
(43) Pub. Date: Sep. 15, 2016

(54) Automation Equipment and Operator System

(71) Applicant: Siemens Aktiengesellschaft, Muenchen (DE)

(72) Inventor: Benjamin LUTZ, Pfinztal (DE)

(21) Appl. No.: 15/048,009

(22) Filed: Feb. 19, 2016

(30) Foreign Application Priority Data
Mar. 11, 2015 (EP) 15158589

(51) Int. Cl. G05B 19/06

(52) U.S. Cl. CPC G05B 19/063; G05B 2219/23287

(57) ABSTRACT

Automation equipment (21) including at least one automation device (9) and an operator system (22) for the visualization and operation of at least one sequencer (SFC) of a sequential control. Objects (24) created from the sequencer (16) are processed during a RUN operation of the automation device (9). The objects (24) parameterize and activate CFC functions (15) loaded into the automation device (9) and defined by a Continuous Function Chart editor. The interaction and link between the objects (24) and the CFC functions (15) are effected via process values (18) and control signals (19). Modification of the sequential control is enabled during the RUN operation of the automation device (9).

### BACKGROUND OF THE INVENTION

1. Field of the Invention

The present invention relates to automation equipment that includes at least one automation device and to an operator system for the visualization and operation of sequencers of a sequential control, wherein objects created from the sequencer are processed during a RUN operation of the automation device, the objects parameterize and activate CFC functions loaded into the automation device and defined by a Continuous Function Chart editor, and the interaction and link between the objects and the CFC functions are effected via process values and control signals.

2. Background of the Invention

It is known from chapter 4 of the Siemens catalog “SIMATIC PCS 7 process control system”, 2014/15 edition, to define an automation solution or a user program or control program for an automation device by means of a graphic editor, which can be executed on an engineering system, in the form of what is known as a “Continuous Function Chart (CFC) editor” comprising ready-made blocks (objects) in accordance with an automation task to be achieved. The user selects the blocks or objects, e.g. a closed-loop controller or counter block, from an available selection of blocks, places the blocks in a function block diagram (e.g. a CFC chart), for example in a drag-and-drop operation, and connects these to one another by mouse click(s). The term “connect” is understood to mean that values are transferred from an output to one or more inputs for communication between the blocks, by way of example. Once the user has defined all functions in the function block diagram, the engineering system generates CFC automation objects or CFC functions which can be read by the automation device. These which objects or functions are loaded into the automation device and there processed for open-loop control of a technical process or to achieve the desired automation task.

The engineering system is furthermore provided with an additional graphic editor in the form of what is known as a “Sequential Function Chart (SFC) editor”, by means of which a user can define a sequential control or a recipe for open-loop control of a batch process, as for example a recipe for the manufacture of synthetic resin, colorants or fertilizer. The SFC editor enables graphic project planning and commissioning of the sequential control, (SFC) objects being created from the sequential control, the objects being loaded for execution into an automation device. The sequential control is provided for status-driven or event-driven execution of production processes based on sequence cascades (sequencers). The sequential control conventionally has a plurality of such sequencers (Sequential Function Charts), which are designed for alternative and/or parallel branching and which comprise a plurality of recipe elements in the form of recipe operations, such as dosing, heating or stirring, as well as transitions.

During a RUN operation of the automation device(s), the (SFC) objects created from the sequential control or from the sequencer (SFC) control the CFC functions—which is to say the SFC objects—created from the CFC chart and activate the subordinate CFC functions. The interaction and link between the SFC objects and the CFC functions are effected via process values and control signals.

An OS server and at least one operator system comprising an OS client is also known from chapter 5 of the aforementioned Siemens catalog “SIMATIC PCS 7 process control system”, 2014/15 edition, which is designed, on the one hand, to operate and monitor the execution of a process to be controlled and is designed, on the other hand, to visualize and to operate an SFC chart. This SFC operation, however, only allows parameter changes of recipe elements of the sequencers or of the sequential control which have already been project planned, for example parameter changes in the form of target value changes, during the RUN operation. Changes to one or more sequencers, for example a change by inserting a new recipe element, are only possible for a new project planning by means of the engineering system, the SFC chart having to be recompiled following this change and the SFC objects having to be loaded into the automation device. A change to the SFC chart during a RUN operation of the automation device is therefore not possible.

### OBJECTS AND SUMMARY OF THE INVENTION

It is accordingly an object of the invention to provide automation equipment by means of which modifications of sequential controls are enabled during a RUN operation of the automation device.

It is a further object of the invention to provide an operator system for visualization and operation of sequencers of a sequential control and which is suitable for use with such automation equipment.

It is particularly advantageous, in accordance with the invention, to reduce the time required for project planning and the testing and optimization of a sequential control. By means of the automation equipment of the invention, an on-line change to the sequential control is possible so that it is no longer required, as in the prior art, to effect changes to the sequential control in an engineering system, to then compile the changed sequential control and to then load the changes into the automation device.

In the operation and monitoring of a technical process or facility to be controlled, the facility operators or operators are among those with the most experience, and often have extensive ideas for optimization and improvement of the respective facility and the automation equipment. Many of these ideas arise from practical experience in using the facility rather than from a theoretical model, as for example a control technology track model. In order to investigate the benefit of these ideas, which require modifications to the sequential control, a complex simulation, as well as the re-planning and re-engineering of the sequential control with subsequent transfer into the automation device, can be dispensed with in accordance with the automation equipment of the invention.

The facility operators (operators) are as a rule also only familiar with the operator system concerning the operation and monitoring of the process or the facility. Working with engineering software does not usually form part of the duties of the facility operators. In order to allow the knowledge of the facility operator to be incorporated as part of an optimization in an optimal manner, the sequential control in the operator system can be optimized on-line without profound engineering knowledge; knowledge with relation to a dedicated compilation and downloading—as in known automation equipment with known engineering systems—is not required.

These and other objects and features of the present invention will become apparent from the following detailed description considered in connection with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference characters denote similar elements throughout the several embodiments and figures:

FIG. 1 is a schematic block diagram depicting components of a first automation equipment arrangement; and

FIG. 2 is a schematic block diagram depicting components of a second automatic equipment arrangement in accordance with the invention.

### DETAILED DESCRIPTION OF THE CURRENTLY PREFERRED EMBODIMENTS

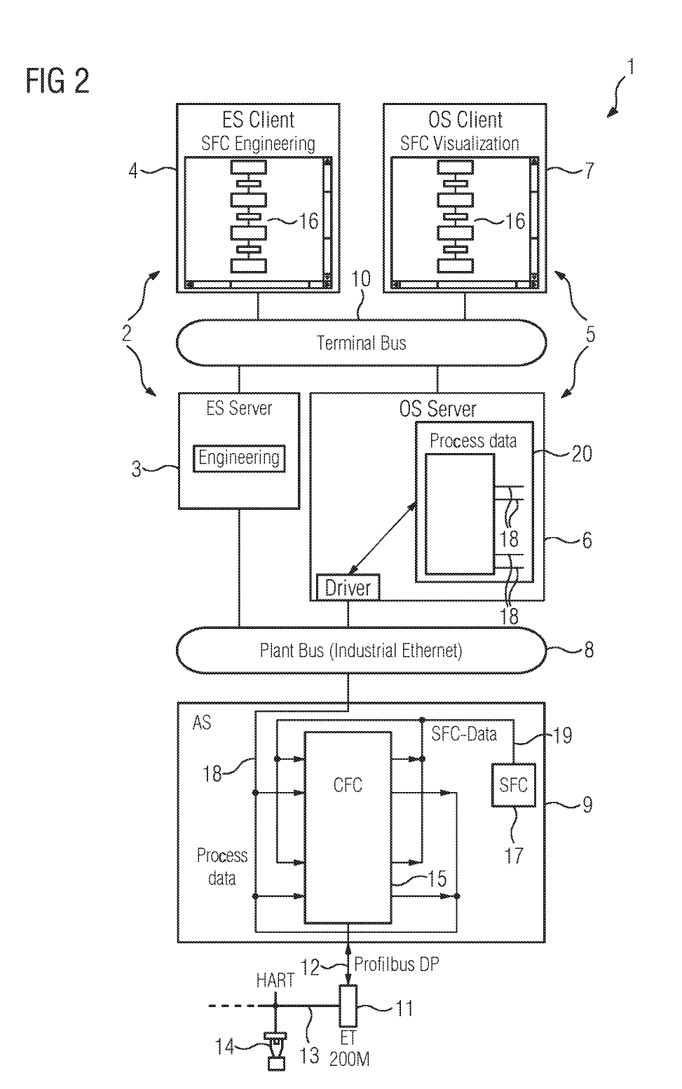

With initial respect to FIG. 2, automation equipment 1 is of a form or construction known in the art. In the FIG. 2 embodiment, the automation equipment 1 comprises by way of illustrative example an engineering system 2, which includes an ES server 3 and an ES client 4, as well as an operator system 5 which consists of an OS server 6 and an OS client 7. The ES server 3 and the OS server 6 communicate via a bus connection 8 with an automation device 9 of the automation equipment 1, wherein the servers 3, 6 and the clients 4, 7 furthermore exchange information via an additional bus 10. The automation equipment 1 moreover has a decentralized periphery 11, which is attached to an automation device 9 via a bus 12, the decentralized periphery 11 being connected to a plurality of field devices 14 (e.g., sensors, actuators) by means of another bus 13.

Through the use of a Continuous Function Chart (CFC) editor that can be executed on engineering system 2, a user can as known graphically define a control program for automation device 8 from ready-made blocks to implement an automation task to be achieved. The user selects the blocks, e.g. a closed-loop controller or counter block, from an available selection of blocks, places the blocks in a function block diagram (e.g., a CFC chart) using for example drag-and-drop manipulation, and connects the blocks to one another by mouse click(s). Once the user has defined all functions in the function block diagram, the engineering system generates CFC functions that can be read by the automation device 9, which functions are loaded into automation device 9 and there processed for open-loop control of a technical process or to achieve the automation task. The CFC functions that are loaded into automation device 9 for execution in process control are indicated by reference numeral 15 (CFC).

The user also graphically defines as known a sequential control (SCF) using a Sequential Continuous Function Chart (SFC) editor that can likewise be executed on the engineering system 2. This conventionally comprises a plurality of sequencers, which in turn have a plurality of recipe elements and transitions, such as recipe elements in the form of recipe operations or recipe functions, as for example dosing, heating or stirring. It is assumed in this illustrative embodiment that a user has defined a sequential control, wherein during the engineering phase a sequencer 16 of the sequential control is depicted on the ES client 4 of the engineering system 2. From this sequential control the engineering system 2 creates objects, which can be processed by the automation device 9, that the engineering system 2 compiles and loads into automation device 9. The objects of the sequencer that are loaded into automation device 9 for processing during process control are identified in FIG. 2 by the reference numeral 17 (SFC). During process control—that is, during a RUN operation of automation device 9—the interaction and link between the objects 17 and the CFC functions 15 are effected via process values 18 and control signals 19 (SFC data). In addition, during process control the sequencer 16 is shown to the operator on the OS client 7, as a result of which the operator can observe which recipe element of the sequencer is currently being processed. Each step of the sequencer is assigned a particular action, which the CFC functions 15 parameterize and activate, wherein corresponding control signals 19 are set. The process values 18 comprise process input values (actual values) that are fed by sensors to automation device 9 and which automation device 9 transmits to OS server 6 for depositing in a process image 20, as well as process output values (target values) that OS server 6 feeds to automation device 9 for activating the actuators.

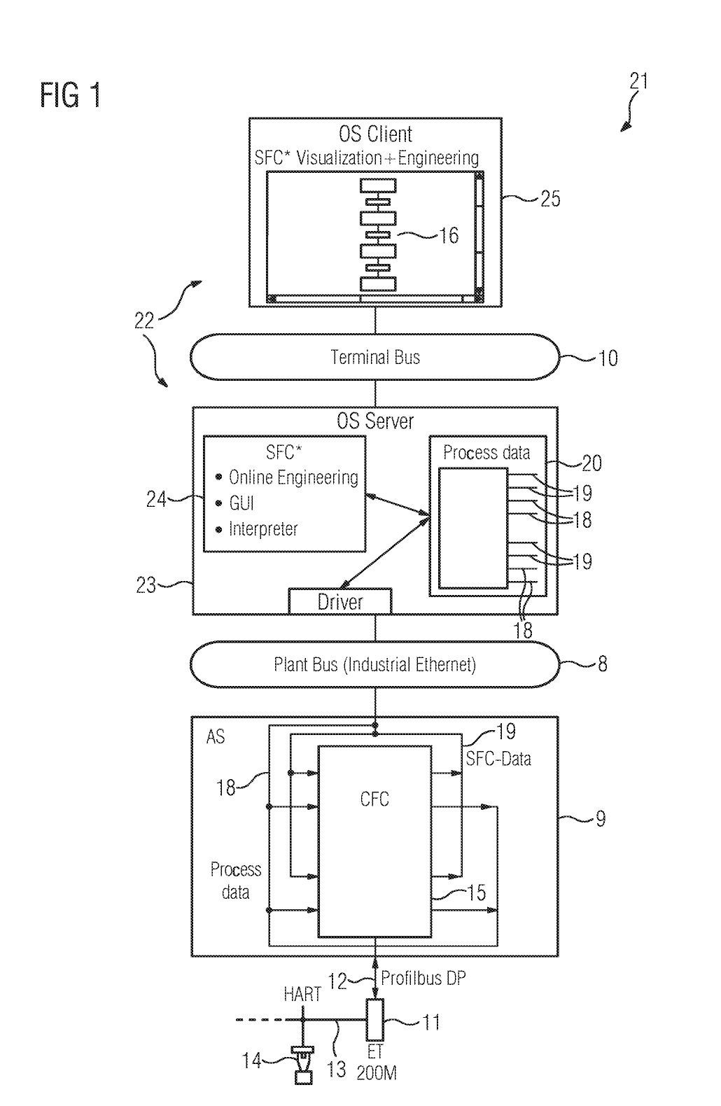

In order to enable modification of the sequencers 16 and thus the sequential control during a RUN operation of the automation device—for example by inserting a further recipe operation “mix”—automation equipment 21 has an operator system 22 (FIG. 1). With continued reference to FIG. 1, the OS server 23 that includes an interpreter for interpretation and processing of the sequential control and for activating the CFC functions 15 in automation device 9, an engineering interface for defining the sequencer by means of an SFC editor that is executable on an OS client 25 of operator system 22, and an interface for visualization and operation of the sequencer 16 during process control. In contrast with known processing of the SCF objects 17 created from the sequencer 16 by means of automation device 9, an OS server 23 of operator system 22 of the automation equipment 21 processes objects of the sequencer 16, which objects are to be processed or can be executed during the process control and are labeled with reference numeral 24 (SFC*). The OS server 23 processes the SFC* objects 24 in an interpretive manner and deposits in the process image 20 both the process values 18 in the form of the process output values (target values) and the SFC data 19. Furthermore, the SFC* objects 24 receive the process values 18 transmitted by the automation device 9 in the process image 20 in the form of process input values (actual values), wherein the interaction and link between the SFC* objects 24 and the CFC functions 15 in automation device 9 are effected as hereinabove described via the process values 18 and the SFC data 19.

By virtue of the interpretive processing of the SFC* objects (SFC*) in OS server 23, a test (debugging and optimizing) is enabled directly during the process control, without execution of compilation and downloading into the automation device in the individual engineering system. The flexibility of the SFC*s is furthermore also particularly suitable for laboratory operation, if the focus is directed towards optimization of the automation process or the recipe by alteration of sequencers or optimization of parameters. During the process control, optimizations can be effected for example by inserting additional sequencers if chemical reactions have not yet entirely concluded due to changed environmental conditions or if parameter alterations are required to compensate for environmental influences or raw material variation.

While there have been shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. It is the intention, therefore, to be limited only as indicated by the scope of the claims appended hereto.

What is claimed is:

1. In automation equipment that includes at least one automation device (9) and an operator system (22) for visualization and operation of a sequencer (SFC) of a sequential control, wherein objects (24) created from the sequencer (16) are processed during a RUN operation of the automation device, wherein the objects (24) parameterize and activate CFC functions (15) loaded into the automation device (9) and defined by a Continuous Function Chart editor, and wherein an interaction and link between the objects (24) and the CFC functions (15) are effected via process values (18) and control signals (19), the operator system (22) comprising:
an interpreter for interpreting and processing of the sequential control and for activating the CFC functions (15) in the automation device (9);
an engineering interface for modifying the sequencer (16) of the sequential control; and
an interface for the visualization and operation of the sequencer (16) of the sequential control.

2. An operator system (22) for automation equipment and operable for visualization and operation of a sequencer (SFC) of a sequential control, wherein objects (24) created from the sequencer (16) are processed during a RUN operation of an automation device of the automation equipment, wherein the objects (24) parameterize and activate CFC functions (15) loaded into the automation device (9) and defined by a Continuous Function Chart editor, and wherein an interaction and link between the objects (24) and the CFC functions (15) are effected via process values (18) and control signals (19), the operator system (22) comprising:
an interpreter for interpreting and processing of the sequential control and for activating the CFC functions (15) in the automation device (9);
an engineering interface for modifying the sequencer (16) of the sequential control; and
an interface for the visualization and operation of the sequencer (16) of the sequential control.
